(19) United States
(12) Patent Application Publication
(10) Pub. No.: US 2025/0085941 A1
(43) Pub. Date: Mar. 13, 2025

(54) METHODS AND SYSTEMS FOR SOFTWARE ENHANCEMENT AND MANAGEMENT USING TALP EXTENSIONS FOR BLOCKCHAIN-BASED PARALLEL AND AI PROCESSING

(71) Applicant: C Squared IP Holdings LLC, Scottsdale, AZ (US)

(72) Inventors: Scott Andrew SMITH, Ocala, FL (US); Christopher Graham SMITH, Aurora, CO (US); Kevin David HOWARD, Mesa, AZ (US)

(21) Appl. No.: 18/957,606

(22) Filed: Nov. 22, 2024

Related U.S. Application Data
(63) Continuation-in-part of application No. 18/586,490, filed on Feb. 25, 2024, now Pat. No. 12,175,224.
Application No. 18/586,490 is a continuation of application No. 18/241,943, filed on Sep. 4, 2023, now Pat. No. 11,914,979.
Application No. 18/241,943 is a continuation of application No. 18/102,638, filed on Jan. 27, 2023, now Pat. No. 11,861,336.
Application No. 18/102,638 is a continuation-in-part of application No. 17/887,402, filed on Aug. 12, 2022, now Pat. No. 11,687,328.
(60) Provisional application No. 63/232,576, filed on Aug. 12, 2021.
(60) Provisional application No. 63/303,945, filed on Jan. 27, 2022.
(60) Provisional application No. 63/602,337, filed on Nov. 22, 2023.
(60) Provisional application No. 63/602,339, filed on Nov. 22, 2023.

(51) Int. Cl. G06F 8/41; G06F 11/36

(52) U.S. Cl. CPC G06F 8/447; G06F 11/3698

(57) ABSTRACT

The present invention relates generally to generating and processing spatiotemporal data transformation objects of an algorithm, and a Time-Affecting Linear Pathway (TALP)-based enhancement and management system that can use blockchain networks to generate and pool TALP predictive analytics.

### CROSS-REFERENCE TO RELATED APPLICATIONS

This application is a continuation-in-part of U.S. patent application Ser. No. 18/586,490, filed Feb. 25, 2024, which is a continuation of U.S. patent application Ser. No. 18/241,943, filed Sep. 4, 2023 and now issued as U.S. Pat. No. 11,914,979, which is a continuation of U.S. patent application Ser. No. 18/102,638, filed Jan. 27, 2023 and now issued as U.S. Pat. No. 11,861,336, which is a continuation-in-part of U.S. patent application Ser. No. 17/887,402, filed Aug. 12, 2022 and now issued as U.S. Pat. No. 11,687,328, and claims priority to and the benefit of U.S. Provisional Patent Application No. 63/303,945, filed Jan. 27, 2022, and this Application claims priority to and the benefit of U.S. Provisional Patent Application No. 63/602,337, filed Nov. 22, 2023, and U.S. Provisional Patent Application No. 63/602,339, filed Nov. 22, 2023, and U.S. patent application Ser. No. 17/887,402 claims priority to and the benefit of U.S. Provisional Patent Application No. 63/232,576, filed Aug. 12, 2021; with each of the listed and referenced applications and disclosures full incorporated herein by reference.

### TECHNICAL FIELD

The present invention relates generally to Time-Affecting Linear Pathway (TALP) systems and, more particularly, to the execution of TALP-based Enhancement and Management (E&M) Systems in blockchain networks using TALPs and pooled TALP predictive analytics, and generating and processing spatiotemporal data transformation objects of an algorithm.

### BACKGROUND OF THE INVENTION

The technology herein extends the teachings of U.S. Pat. No. 11,687,328 (Method and System for Software Enhancement and Management, E&M System) and U.S. Pat. No. 11,861,336 and its continuation U.S. Pat. No. 11,914,979 (Software Systems and Methods for Multiple TALP Family Enhancement and Management, MTF E&M System), which are fully incorporated herein by reference. Those references discuss the use of TALPs to process, pool, and predict algorithm behavior. This invention shows that the enhancement and management systems can be executed in blockchain networks. Pools of algorithms are herein shown to be applicable to simulation and modeling not only on the single system, client-server network, cloud-based networks, and ad-hoc networks but also on the networks formed for blockchains. Considering that blockchain networks are heterogeneous, they require a means to balance the workload of a model or simulation placed on them. Time affecting linear pathway (TALP)-based parallelization with its ability to dynamically manage workloads was chosen herein to enable modeling and simulation on blockchain networks. TALPs also show that they are auto-selectable, removing the need for the traditional “smart contracts” used by blockchains to execute software codes. This invention further extends concepts in blockchain physical network usage, combining automatic distributed parallel processing and embedded generative AI processing to reduce the processing time, programming, and single user processing energy costs associated with managing and enhancing complex software systems.

In 1991 Stuart Haber and W. Scott Stornetta invented the concept of blockchains in order to have a safe method of time and date stamping documents. This was shown to be useful for document/source code revision control. In 1994 Nicholas Szabo introduced the concept of “smart contracts” which are a set of digital promises specified as protocols and computer programs used to enforce some ownership rights to digital objects by the automatic execution, control, and/or event documentation of the use of that object. This was followed in 2000 by Stefen Konst's theory of cryptographic secure chains, which made it possible to have linked chains of data (like those used in blockchains) to encrypt entire chains of documents such that each node in the chain remained protected regardless of the number of links in the chain. Hal Finney's 2004 concept of reusable proof-of-work introduced the use of a trusted server to ensure that, once noted, past versions of a document in a blockchain could not be altered by non-trusted servers. Finally, Satoshi Nakamoto combined all of these concepts together in his 2008 paper titled “Peer-to-Peer Electronic Cash System,” universally recognized as the start of bitcoins.

Blockchains in the current art are used for distributed data storage. This data storage is used in a variety of ways. For example, the decentralized read-only version can be used as a distributed ledger to track transactions, game moves, and the like. The use of tokenization with those distributed ledgers protects sensitive data stored in the ledger.

The use of blockchains was extended to include smart contracts, which allows a computer program to be called from within the blockchain itself. Although the use of smart contracts does link the storage and use of computer programs to a blockchain, such computer programs are serial and do not take full advantage of the network on which it resides. Because of processing time limits, the complexity of the computer programs that can be executed from a smart contract in a block is limited. Further, the calling triggers that invoke the execution of the blockchain-stored computer programs must be pre-programmed, limiting contract flexibility.

In contrast, previous focuses of the art were the generation and the automatic decomposition of source codes and algorithms into TALPs whose behaviors are defined by self-constructed intrinsic predictive analytics, which are used for automatic parallelization of software code, decreasing processing time and allowing for increased software complexity. These analytics are also used to automatically call the correct software based solely on detected input variable values, removing the need for smart contract pre-programming.
1) U.S. Pat. No. 10,496,514-System and Method for Parallel Processing Prediction
2) U.S. Pat. No. 11,789,698-Computer Processing and Outcome Prediction System and Method
3) U.S. Pat. No. 11,520,560-Computer Processing and Outcome Prediction System and Method
4) US Patent App. Pub. 2023/0325319-Method and System for Software Multicore Optimization
5) US Patent App. Pub. No. 2023/0281543-Software Methods and Systems for Automatic Innovation Determination
6) US Patent App. Pub. No. 2022/0400163-Methods and Systems to Execute TALPs Using Distributed Mobile Applications as Platforms
7) US Patent App. Pub. No. 2024/0168758-Systems and Methods of Automatically Constructing Directed Acyclic Graphs (DAGs)
8) US Patent App. Pub. No. 2024/0119109-Methods and Systems for Time-Affecting Linear Pathway Extensions

Each of the above-referenced publications and disclosures are fully incorporated herein by reference. Once decomposed from a source code or algorithm, TALPs were shown to be automatically selectable and executable using the input variable values. Not only are TALPs and their associated intrinsic predictive analytics shown to be automatically selected but also able to automatically convert an existing computer program or algorithm into their maximum performance parallel processing form, which only uses the network resources required to process the current input dataset.

In 1959 IBM's Arthur Samuel pioneered the concept of machine learning (ML), for data matching. The concept of information extraction got widespread use in 1987 by the US Navy's MUC-1 Naval operations message system with significant support by the US Defense Advanced Research Projects Agency throughout the 1990s. The proliferation of the World Wide Web after its introduction in 1990 by Tim Berners turned the internet into a series of interlocked documents making it accessible to computer-based information extraction. There have been many tools created to extract text-based information: naïve Bayes classifiers, Support Vector Machines, Multinomial logistic regression, recurrent neural networks, and maximum-entropy Markov models, to name a few, which use a regression analysis and/or low-dimensional classification schemes. Although these models have had success with smaller datasets, they require supervised training of the dataset. The amount of data needed to train a system to represent accurate natural language processing is very large and thus the amount of training time required makes the effort very costly.

In 2018 Jacob Devlin created a new technique called the Bidirectional Encoder Representations from Transformers (BERT) model, which was modeled after the system proposed by Polosukhin et. al. in their 2017 paper, “Attention is All You Need.” BERT and its successors, Generative Pre-trained Transformer (GPT, GPT2, and GPT3), Transformer XL (XLNet), Robustly Optimized BERT (ROBERTa), etc., use high-dimensional classification schemes like embedded transformers.

Each of the above-referenced, listed, or identified publications and disclosures are fully incorporated herein by reference.

### SUMMARY OF THE INVENTION

The above and other aspects of the embodiments are described below with reference to the accompanying drawings. This invention utilizes the underlying physical infrastructure of a blockchain network as a parallel processing and generative Artificial Intelligence (AI) system used to process the complex software needed for management and control to, for example, model, simulate, and predict the behavior of multiple, combined entities.

It should be noted that generative AI is a statistically based discipline and as such the lessons learned for one area of knowledge are typically not applicable to another area of knowledge. Further, knowledge in the same area gleaned using a different learning model may not be compatible. Combining a Time-Affecting Linear Pathway's (TALP's) ability to automatically select processing elements based upon input values with generative AI's statistical decision-making ability allows for decisions from the best learning model to automatically occur, thus enhancing generative AI.

The use of TALPs in blockchains will allow for the dynamic optimization of smart contract processing performance. As such, blockchains and their associated smart contract art can be enhanced by fully utilizing the underlying physical computing network with the automatic parallelization of smart contract-associated protocols and software, using TALP-based automatic conversion of algorithms and source code, automatic dynamic parallel resource selection, and automatic parallel code execution.

The use of TALPs to automatically manage the processing times of heterogeneous physical networks and the further ability of TALPs to automatically select both the proper decision networks used in generative AI and a general-purpose software algorithm or code means that the heterogeneous physical networks associated with blockchains can be effectively used as a platform for the execution of complex codes standard and AI software systems.

It has been shown in the aforementioned references/publications/art that when either the Enhancement and Management (E&M) System or the Multiple TALP Family Enhancement and Management (MTF E&M) System is used in automated structured finance systems in order to simulate an asset, that asset must first be converted into algorithmic form, which is then converted into source code.

Examples of the expansion of the reference/art software management systems and methods for structured finance included herein: the processing associated with multiple firms, multiple partner categories, and asset custody performed using only the physical hardware associated with a blockchain network, as are multiple smart contract types; the processing associated with the tokenization of risk return allocation vehicles, limited partner fractional tranches, and pre-initial coin offering options; and the execution of robotic process automation applications using parallel TALP processing on directed acyclic graphs, asset modeling, asset behavior prediction, providing automated general partner decisions and secondary operations.

In various embodiments, methods and systems are provided for generating and processing Spatiotemporal Data Transformation (STDT) object characteristics for an algorithm. The capacity of the hardware and software used by the algorithm (advanced space complexity), and the processing time of the algorithm (advanced time complexity), can be combined into a single structure called an STDT object. Each STDT object has its own variable attribute data set 204 that is dynamic, automated, and programmable.

### BRIEF DESCRIPTION OF THE DRAWINGS

The accompanying drawings, which are incorporated herein and form part of the specification, illustrate various embodiments of the present disclosure and, together with the description, further explain the principles of the disclosure and enable a person skilled in the pertinent art to make and use the embodiments disclosed herein. In the drawings, like reference numbers indicate identical or functionally similar elements.

FIG. 1 is a diagram of the software stacks required on either public or private blockchain networks used not only to perform transactions with such transactions recorded on a distributed ledger but also build, parallelize, execute, and log the outcomes of software codes that have been decomposed into Time-Affecting Linear Pathways (TALPs) used to enhance generative AI-based decision processing, in accordance with embodiments of the present invention.

FIG. 2 is an example of blocks in a blockchain public network containing TALP enhancements, in accordance with embodiments of the present invention.

FIG. 3 is a diagram showing an example of the physical processing environment used to house components of the TALP-enhanced blockchains. Shown is a single n processor server highlighting one of the server's processors, which contains n cores with access to the server's random access memory (RAM) housing some or all components of a TALP-enhanced blockchain, in accordance with embodiments of the present invention.

FIG. 4 is a diagram showing an example of a physical client-server system with multiple rack-mounted servers housing some or all of the components of a TALP-enhanced blockchain, in accordance with embodiments of the present invention.

FIG. 5 is a diagram showing an example of a physical tiered edge-based blockchain public network, connected to a trusted private network, with each server containing some or all of the components of a TALP-enhanced blockchain, in accordance with embodiments of the present invention.

FIG. 6 is a diagram showing an example of the general MTF E&M system which can receive datasets, algorithms, or software codes and convert them into optimized families or cross-families of TALPs for execution by various classes of users. The MTF E&M system, described in the art (U.S. Pat. No. 11,687,328), can be executed as TALPs on a TALP-enhanced block-chain public network, in accordance with embodiments of the present invention.

FIG. 7 is a diagram showing an example of the conversion of asset data into asset TALPs, the extraction of analytics (prediction curve fits) from the asset historic and current data, and the use of such prediction curve fits (TALP models) in a directed acyclic graph-based decision network (payment decision network), in accordance with embodiments of the present invention.

FIG. 8 is a diagram showing an example of the use of TALPs to automatically select a decision group, allowing the learning of particular models to become an integral part of a more general learning model, in accordance with embodiments of the present invention.

FIG. 9 is a diagram showing an example of a blockchain physical network as a parallel TALP execution network. Each node is a processing element (PE) (typically a core) within a processor, with storage capacity for an object (memory capacity) and a data transmission rate (bandwidth), in accordance with embodiments of the present invention.

FIG. 10 is a diagram showing the definition of a spatiotemporal data transformation object, that is, an object consisting of data, data arrival time (Start Time), and dataset receipt completion time (End Time), in accordance with embodiments of the present invention.

FIG. 11 is a diagram showing the past, present, and future (predicted) potentiality of a spatiotemporal data transformation object, in accordance with embodiments of the present invention.

FIG. 12 is a diagram showing examples of the spatiotemporal data transformation object data converted to input variable attribute sets, depicting memory capacity and memory use levels on processing time and processing stage, in accordance with embodiments of the present invention.

FIG. 13 is a diagram showing examples of hierarchical spatiotemporal, temporal, and spatial objects, depicting time balancing using either parallel temporal or parallel spatial processing combined with serial processing, in accordance with embodiments of the present invention.

FIG. 14 is a diagram depicting examples of multiple spatial allocations (memory) for hierarchical data processing storage clusters over time, in accordance with embodiments of the present invention.

FIG. 15 is a diagram showing examples of multiple complex tasks for a single user (institutional data storage processing) on an in-house system compared to multiple disparate tasks for multiple simultaneous users over time, in accordance with embodiments of the present invention.

FIG. 16 is a diagram showing two examples of processing and storage chain combinations using multiple hierarchical processing (nested or clustered), in accordance with embodiments of the present invention.

FIG. 17 is a diagram showing an example of a pooled TALP chain whose output is fully or partially in a feedback loop into the original TALP chain (output-of-interest values) with feedback loops occurring every processing epoch (time period), in accordance with embodiments of the present invention.

FIG. 18 is a diagram showing a detail of a pooled TALP chain receiving multiple feedback loops (output-of-interest values) and generating timing, values, and value errors, in accordance with embodiments of the present invention.

FIG. 19 is a diagram showing a detail of a temporally linked, predicted TALP with timing and a feedback loop, in accordance with embodiments of the present invention.

FIG. 20 is a diagram showing a detail of a temporally linked, predicted TALP with generated outputs and alerts, in accordance with embodiments of the present invention.

### DETAILED DESCRIPTION OF PREFERRED EMBODIMENTS

The present invention has the ability to extract the analytics associated with some set of data objects (e.g., laboratory data, sensor data, or financial data, etc.) converting those data objects into one or more Time-Affecting Linear Pathways (TALPs) and called herein object-TALPs.

TALPs are generated from paired Input/Output (I/O) datasets or from the decomposition of algorithms and/or software codes. TALPs are executed using test input data to generate prediction polynomials. System-generated TALPs can be merged with enhancement TALPs. Using TALP-associated prediction polynomials and acceptance criteria comprised of paired I/O datasets that represent acceptable TALP behavior, system-generated and enhanced TALPs are simulated and selected. The TALP-associated prediction polynomials of selected TALPs are then modeled using actual input data values from external platforms, and their output data values pooled, discretized, and optimized for use by, or distribution to, system users. Alternatively, the TALP-associated prediction polynomials of selected TALPs are executed using the input values from the TALP Family Selection criteria for inclusion in TALP Families. The associated output values of these TALP-associated prediction polynomials are compared to the associated output values of the TALP Family Selection criteria. TALP-associated prediction polynomials from each family can be re-executed using input from the Proposed TALP Cross-Family Structure criteria, with output value comparison for inclusion in one of those structures. TALP-associated prediction polynomials for each TALP in each TALP Family and each TALP Cross-Family are modeled using actual input data from external platforms, and their output data values pooled, discretized, and optimized for use by, or distribution to, system users.

A TALP is an execution pathway through an algorithm or software code which includes looping structures. TALPs allow for the direct and automatic selection of a pathway through an algorithm or software code via the examination of the values of input non-loop-control variable attributes. Time prediction for TALPs occurs through varying the input loop control variable attributes and generating a time prediction polynomial. This means that examining the values of input loop control variable attributes is enough to know the processing time of a TALP. The output value prediction of a TALP occurs through varying the attribute domain of the input variable attributes that affect output values forming an output prediction polynomial. This means that it is possible to know the output values of a TALP through the examination of the input variables. Various TALP methods and systems are disclosed in U.S. Pat. No. 11,520,560, which is hereby fully incorporated herein by reference and can be implemented with various aspects, embodiments, methods, and systems of the present invention.

Object-TALPs are used in two different ways: simulation/modeling and decision group selection. Each object-TALP has an associated set of extracted analytics (prediction curve fits) which enable the prediction of both spatial and temporal effects for the object-TALP. These predicted spatiotemporal effects are used not only to predict the processing times and memory allocation required by the object-TALP but also the predicted timings for generated output values of various object-TALP associated events, e.g., payment schedules (time complexity), cashflows (output complexity), volumetric changes (space complexity), etc. These analytics are also shown herein to be capable of being used in decision networks. Such networks combined with an object-TALP means that the data predicted by an associated object-TALP's analytics can be used to make complex decisions in the network or simulate various affects.

Consider that for each algorithm there is a set of TALPs and for each TALP there is a set of self-constructed analytics. These analytics link input variable attributes and their values with data discretization, the ability to dynamically allocate the required memory, the ability to dynamically determine the number and types of processing elements assignable (cores, processors, servers, etc.), the ability to dynamically assign processing elements to parallel instances of TALPs, the type of cross-communication possible between multiple parallel TALP instances, the ability to perform dynamic loop unrolling matched to the input dataset values, and the ability to dynamically utilize the number of communication channels available. The linkage between algorithms, TALPs, and various hardware/software configurations mean that each algorithm is locally “aware” of both the available hardware, the input data values, and the effect of the input data values on the hardware allocation and utilization. Consider further that the ability to spawn the most effective number of TALP instances and the effect of those instances on compute resources means that both the hardware and software metamorphosize to optimize the total system performance each time a new input dataset is presented. Since the algorithm's dataset to hardware configuration and reconfiguration is self-generated, we can say that such a system is a Locally Self-Aware Metamorphic (LSAM) computing system.

Multiple TALP Family Enhancement and Management (MTF E&M) systems contain software modeling and simulation components. Because of the computational complexity inherent in such systems and because the processing elements of many of public blockchain hosting hardware are mobile devices, those hosting processing elements would not normally be able to perform the needed processing. Distributed parallel processing could decrease the work per processing element enough so that mobile devices could perform the needed processing. However, another problem with networks of mobile devices is their heterogenous nature. This means that both available memory and available processing performance can vary from device to device. TALP-based parallelization provides both advanced time complexity and advanced space complexity. The advanced forms of time and space complexity use input variable attribute values and their effect on loop iterations (processing time) and memory allocation rather than aggregate input size. This allows a network to decompose the required input variable values per processing element type to perform load balancing, ensuring that the MTF E&M components can be processed using dynamic resource allocating TALP-based parallel processing techniques.

The output data from the analytics of a group of object-TALPs is shown herein to be poolable, with the pooled data useful in decision networks, outcome optimization, and output data distribution determination.

Various devices or computing systems can be included and adapted to process and carry out the aspects, computations, and algorithmic processing of the software systems and methods of the present invention. Computing systems, devices, or appliances of the present invention may include a computer system, which may include one or more microprocessors, one or more processing cores, and/or one or more circuits, such as an application-specific integrated circuits (ASICs), field-programmable gate arrays (FPGAs), graphics processing units (GPUs), general purpose graphics processing units (GPGPUs), tensor processing units (TPUs), language processing units (LPUs), etc. Any such device or computing system is defined as a processing element herein. A server or cloud processing system for use by or connected with the systems of the present invention may include a processor, which may include one or more processing elements. Further, the devices can include a network interface or a bus system in cases where the processing elements are within the same chip. The network interface is configured to enable communication with a communication network, other devices and systems, and servers, using a wired and/or wireless connection.

The devices or computing systems may include memory, such as non-transitive, which may include one or more non-volatile storage devices and/or one or more volatile storage devices (e.g., random access memory (RAM), cache memory, etc.). In instances where the devices include a microprocessor, computer-readable program code may be stored in a computer-readable medium or memory, such as but not limited to magnetic media (e.g., a hard disk), optical media (e.g., an OVO), memory devices (e.g., random access memory, flash memory), etc. The computer program or software code can be stored on a tangible, or non-transitive, machine-readable medium or memory. In some embodiments, computer-readable program code is configured such that when executed by a processing element, the code causes the device to perform the steps described above and herein. In other embodiments, the device is configured to perform steps described herein without the need for code.

It will be recognized by one skilled in the art that these operations, algorithms, logic, method steps, routines, sub-routines, components, and modules may be implemented in software, in firmware, in special purpose digital logic, and any combination thereof without deviating from the spirit and scope of the present invention as recited within the claims attached hereto.

The networks, devices, appliances, or computing devices may include an input device or devices. The input device(s) is (are) configured to receive an input from either a user (e.g., admin, user, etc.) or a hardware or software component as disclosed herein in connection with the various user interface or automatic data inputs. Examples of an input device include data ports, keyboards, a mouse, a microphone, scanners, sensors, touch screens, game controllers, and software enabling interaction with a touch screen, etc. The devices can also include an output device. Examples of output devices include monitors, televisions, mobile device screens, tablet screens, speakers, remote screens, screen less 3D displays, data ports, HUDs, etc. An output device can be configured to display images, media files, text, or video, or play audio to a user through speaker output.

The term communication network includes one or more networks such as a data network, wireless network, a telephony network, or any combination thereof. It is contemplated that the data network may be any local area network (LAN), metropolitan area network (MAN), wide area network (WAN), the internet, cloud computing platform, or any other suitable packet-switched network, such as a commercially owned, proprietary packet-switched network, e.g., a proprietary cable or fiber-optic network. In addition, the wireless network may be, for example, a cellular network and may employ various technologies including global system for mobile communications (GSM), internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WIFI), satellite, mobile ad-hoc network (MANET), quantum entangled qubit channels, and the like.

The use of Multiple TALP Family Enhancement and Management, MTF E&M System, is on standard networks, (multicore, multiprocessor, multi-server, and the like). A recent method of edge computing is the blockchain network. This type of network offers safe distributed databases, the ability to call software from within the network, and distributed ledgering services. Like most distributed network computational nodes, herein called Processing Elements (PEs), are heterogeneous; that is, there can be a mixture of PE types each with different processing performance and data storage capabilities. This makes it difficult to use such networks for advanced modeling and simulation. This invention combines blockchain networks, TALPs with their associated analytics, and generative AI to create a new type of computing platform called TALP-Blockchain Networks (TBNs). These networks are shown to be able to perform modeling and simulation. The use of TBNs in the processing of parallelized MTF E&M systems is shown. Finally, TALP-based AI decision making is introduced.

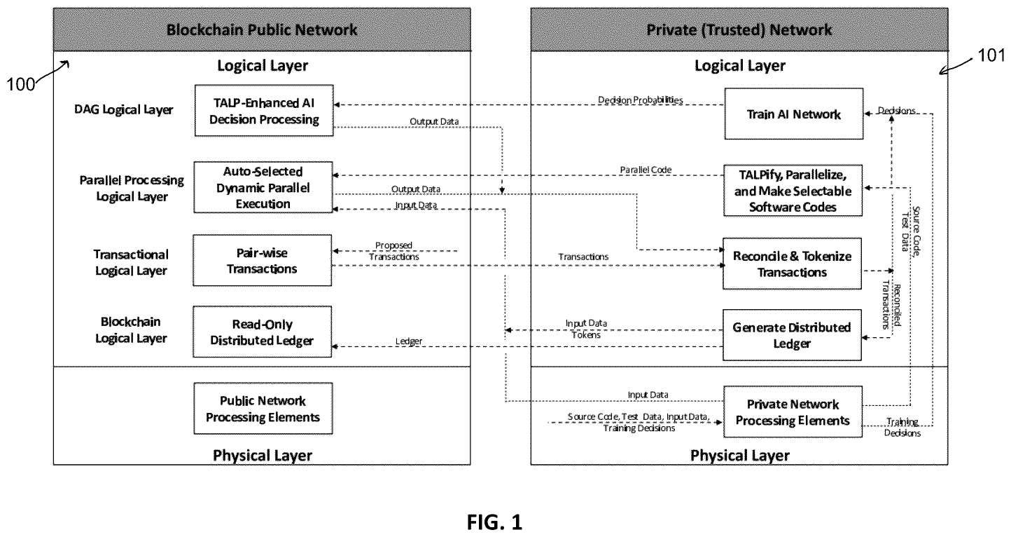

Referring to FIG. 1, a standard blockchain data block 100 is shown to be enhanced. In addition to the standard distributed ledger that is generated by trusted nodes 101 (herein shown as part of a trusted network) and distributed to each member of the public network, parallel TALPs and decision groups are shown to be included in the blockchain network. Select data is transmitted from the public nodes to a trusted node. One example is the use of the “reconcile transactions” portion of the trusted network, which receives data from active transactions, reconciles the transactions, and places the reconciled transaction into a time-stamped ledger for public distribution. Another example is the TALP decomposition, as shown in U.S. Pat. No. 11,789,698 and called herein “TALPification,” of algorithms and software codes by trusted users on the trusted network, with the “TALPified” algorithms and software codes automatically parallelized, also shown in U.S. Pat. No. 11,789,698, and distributed to the public network for execution initiated only by the trusted network. Since a MTF E&M System can be depicted as a set of TALPs when applied specifically to structured finance, then multiple firms, partner categories, and asset custody can be processed using only the physical hardware associated with a block chain network, as are multiple contract types. Each of the above-referenced, listed, or identified publications and disclosures are fully incorporated herein by reference. In order to obfuscate any data values associated with risk return allocation vehicles, limited partner fractional tranches, or pre-initial coin offering options, as defined for a MTF E&M System, such data must be tokenized.

Decision groups formed from the generation of conditional probabilities of a training data set in the trusted network are distributed to the public network for execution by nodes in the trusted network. Data from both the non-AI associated TALP parallel execution and the AI decisions are transmitted from the various public nodes to the “reconcile transactions” portion of the trusted network that places the reconciled data into a time-stamped distributed database (acting as an extension to the general distributed ledger system).

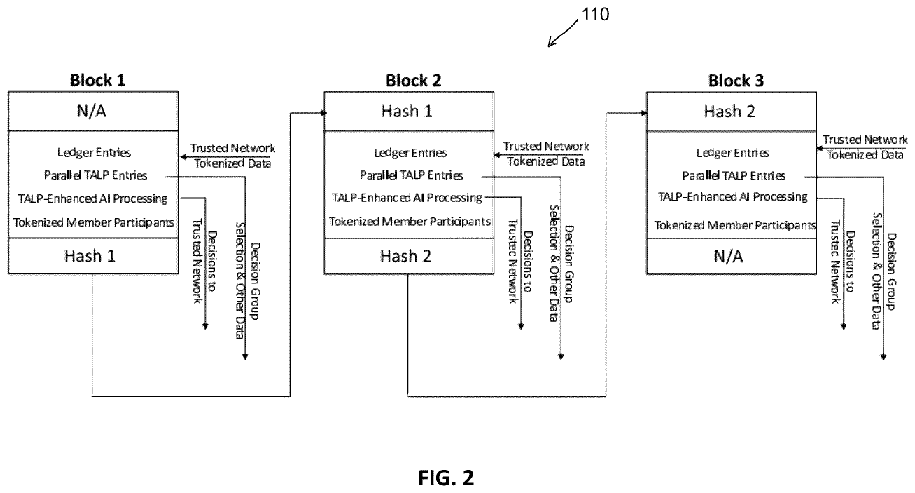

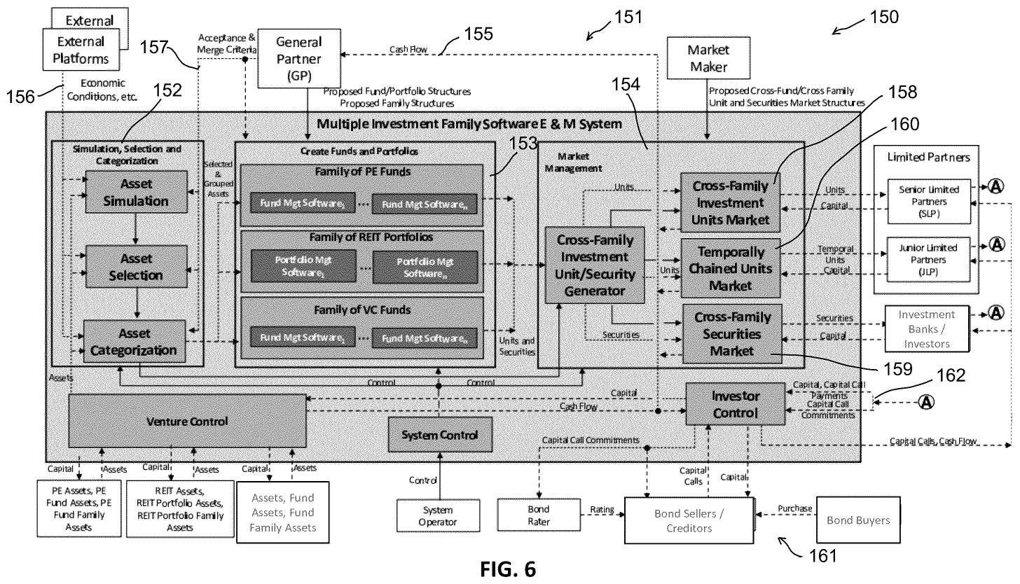

Referring to the diagram 110 of FIG. 2, the public blockchain is shown to consist of a chain of time-stamped, hash code protected ledgers (including those associated with distributed databases), parallelized TALPs, TALP-enhanced generative AI decision groups as well as access to member hardware. Data from and to the trusted network is shown to be part of each link in the blockchain. Since the entire blockchain is accessible to a public network (as read only), tokenization is used to secure sensitive data, such as how to access other member hardware. Parallel TALP entries include the TALP-parallelized Multiple Investment Family Software E&M System, as shown in FIG. 6.

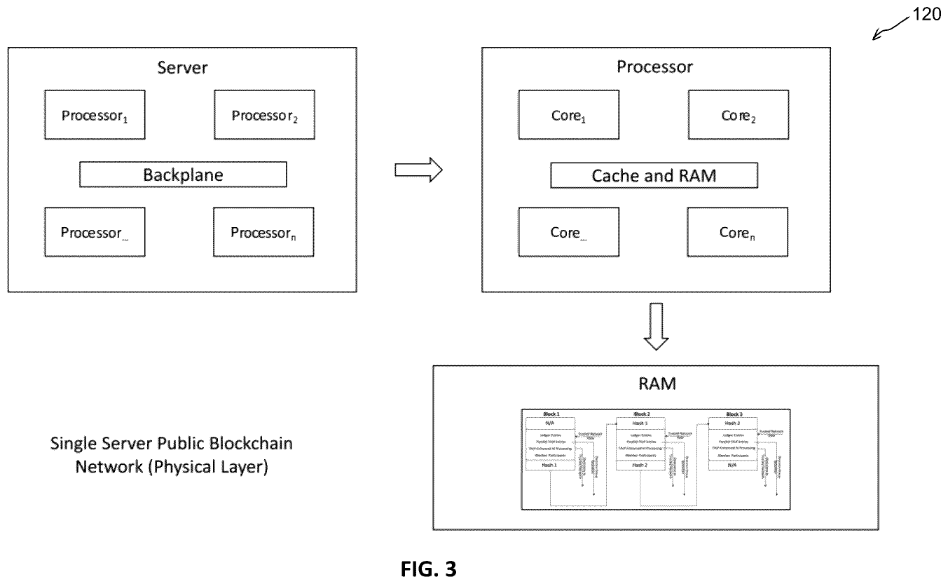

The public network of the enhanced blockchains defined by the current invention can use various physical processing and connection methods as shown in FIG. 3 through FIG. 5. Referring to the diagram 120 of FIG. 3, a multi-processor system with each processor containing multiple cores and each core processes a public copy of the enhanced blockchain software. Parallel processing of the software code on this system is accomplished on two different levels: multicore parallel processing, using shared memory for multicore data communication, and multi-processor parallel processing, using the motherboard backplane for multi-processor data communication. Any required parallel cross-communication will use the appropriate data communication for each level of parallel processing.

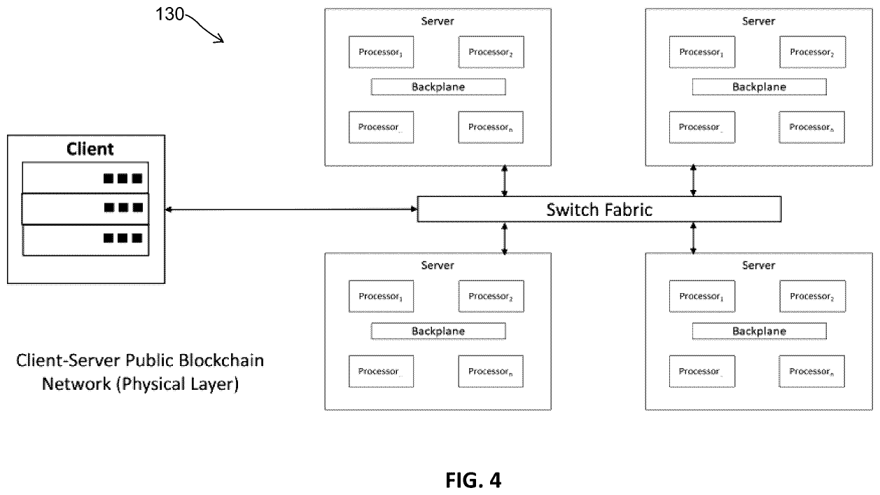

Referring to the diagram 130 of FIG. 4, a multi-server client-server system is shown that contains a public copy of the enhanced blockchain. Parallel processing software code on this system is accomplished on three different levels: multicore parallel processing, using shared memory for multicore data communication; multi-processor parallel processing, using the motherboard backplane for multi-processor data communication; and multi-server parallel processing, using a switch fabric for multi-server data communication. Any required parallel cross-communication will use the appropriate data communication for each level of parallel processing.

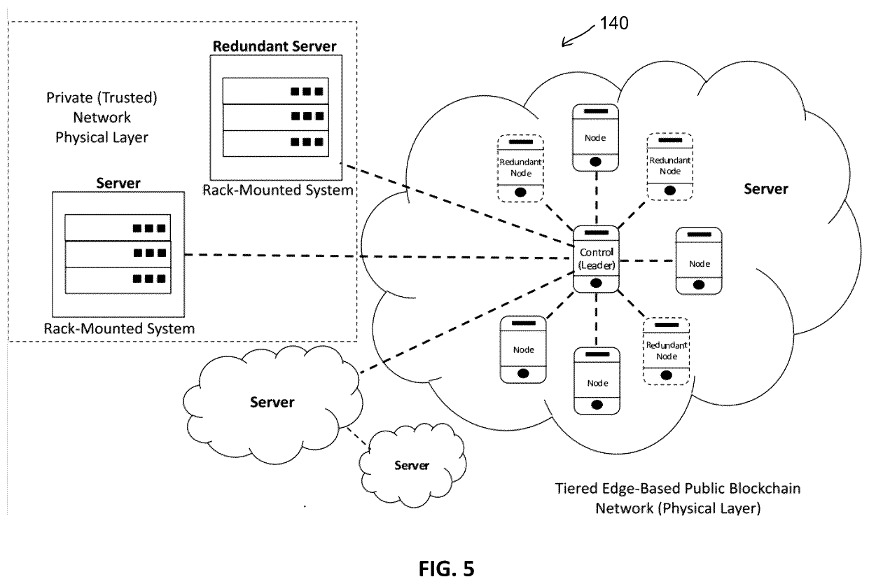

Referring to the diagram 140 of FIG. 5, a multi-tiered edge-based system is shown that contains a public copy of the enhanced blockchain. Parallel processing software code on this system is accomplished on three different levels, multicore parallel processing using shared memory for multicore data communication, multi-processor parallel processing using the motherboard backplane for multi-processor data communication, and multi-server parallel processing using the Internet for multi-server data communication. Any required parallel cross-communication will use the appropriate data communication for each level of parallel processing.

Referring to the diagram 150 of FIG. 6, an example of the MTF E&M System 151 is shown applied to structured finance, composed of three primary components: simulation, selection and categorization 152; fund and portfolio generation 153; and market management 154. The users of the system generate the inputs, consume the outputs of the system, and are called actors. There are fourteen primary actors that use the system: portfolio management software, family of funds or family of portfolios management software, general partners (GPs), investors, limited partners (LPs), junior limited partners, senior limited partners, bond sellers, rating agencies, venture principals (CEOs, organization presidents, etc.), asset owners, external platforms, market makers, and system operators.

The MTF E&M System 151 offers a unique way for these actors to interact to enhance the investment returns generated by fund management software and reduce the investment risk associated with funds managed in the conventional manner. In a way analogous to how an assembler or compiler receives source code and converts that source code into a new form that can cause electronic hardware to follow a set of given rules, the MTF E&M System 151 takes fund, venture, asset, economic data, and investor information and converts it into a risk reduction, return enhancement form that causes cashflows to follow a new set of financial rules, to the benefit of the actors that use the system in a fully automated manner.

Venture, asset, investor, and fund family information can be obtained as managed data from one or more fund, portfolio, family of funds, or family of portfolios management systems or as unmanaged data from input data screens. The already managed and the not-yet managed data can be combined for either direct or indirect investment purposes.

First, cashflows and risk 155 from various assets of ventures, real estate investment trusts, private equity and other funds are used, along with economic conditions 156, to simulate asset behavior over time. Using the results of the simulations and acceptance criteria 157 from the GPs, assets are selected for inclusion then, using merge criteria from GPs, combined or pooled into one or more category groups of like assets.

Given investment pool data of like assets and a proposed fund or portfolio structure, group modelling is performed to generate a set of new funds and portfolios, associated with a set of investment units called principal invested in the portfolio (PIP) units, as well as rating data for the use of bonds and derivatives. PIPs can be further associated with prioritized or non-prioritized units, depending on the proposed fund or portfolio structure. These funds and portfolios can be further combined into families of funds and families of portfolios, given proposed family structures.

The newly created funds, portfolios, fund families, and/or portfolio families and managed funds, portfolios, fund families, and/or portfolio families can be combined into a set of cross-fund/portfolio/family investment markets 158 using proposed cross-fund/cross-family unit and security market structures 159 from the market maker. Some of the market maker data can be used to define a chain of temporal PIP units 160 grouped as a single sellable unit. PIP units, whether chained or unchained, can be associated with prioritized unit categories, which are structured family of fund ownership units to be obtained by different classes of limited partners.

Bonds 161 may be used to purchase marketplace PIP assets that are associated with prioritized unit categories, in which case the limited partners provide a capital call commitment 162 to increase the bond rating and gain control of the assets' cashflow and maturity liquidation value. The percentage of PIP ownership, the capital call order, and the preference or payment order associated with the different prioritized marketplace PIP unit types that are associated with the prioritized unit categories that are further associated with various investor categories allow for multiple risks and returns to be associated with the same fund, portfolio, family of funds and/or family of portfolios.

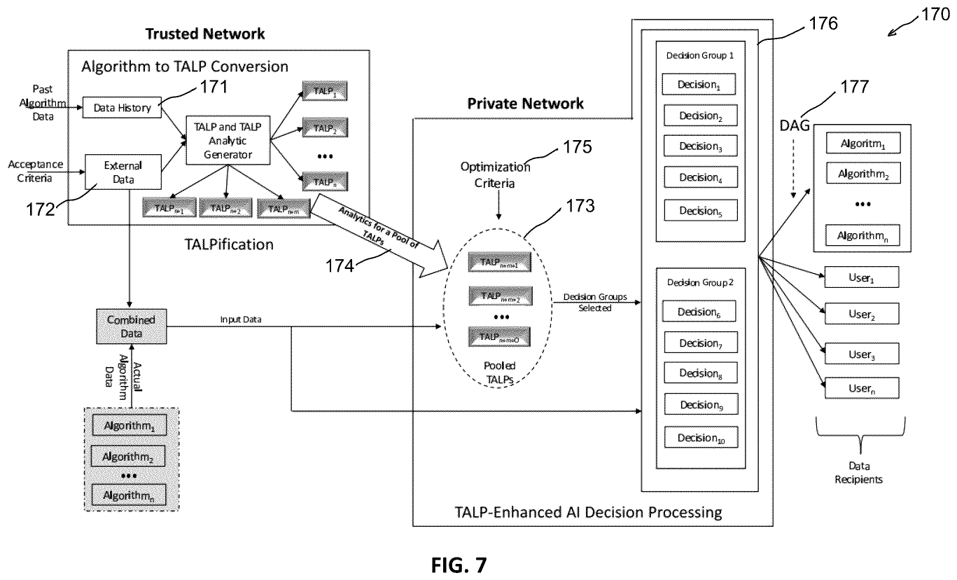

Referring to the diagram 170 of FIG. 7, consider that the TALP definition of an algorithm contains its associated analytics in the form of predictive curve fits. Further consider that the outputs of the predictive curve fits can generate the data used as the basis of a decision network's decisions. First, a pool of assets is converted into algorithmic form by using both historic data 171 and external data 172 as inputs to the assets in order to define the various relationships between the inputs and a set of associated output values. These relationships are then used in the conversion of pooled asset data into a pool of TALPs 173 and their associated prediction curve fits, analytics 174. Next a set of acceptance/optimization criteria 175 is used to form the probabilities of a decision network. The decisions (probability tables) 176 of the decision network come from attributes and values of the acceptance criteria 175. Finally, the decision network's decision points are informed by the output of analytics of the pooled TALPs.

Combining other concepts, systems, and methods from the identified art with the extraction of the inherent analytics of a TALP, various aspects of an asset combined with externally sourced input data along with the acceptable criteria needed to optimize, merge and distribute data from TALP pools, each associated with input variable attribute value ranges and timings, can be modeled. TALP pools can be executed in parallel for greater performance, or serially. In addition, each analytic of each TALP can be executed in parallel creating predictable high-performance effects. Asset modeling and asset behavior prediction using parallel TALP processing on Directed Acyclic Graphs (DAGs) 177 enhance automated general partner decisions, secondary operations (e.g., cash flow analysis, continuous accounting, bond management, collateralization, capital call ordering and management, temporal unit management, asset associated securities, and on-demand limited partner interface generation), and the execution of robotic process automation applications.

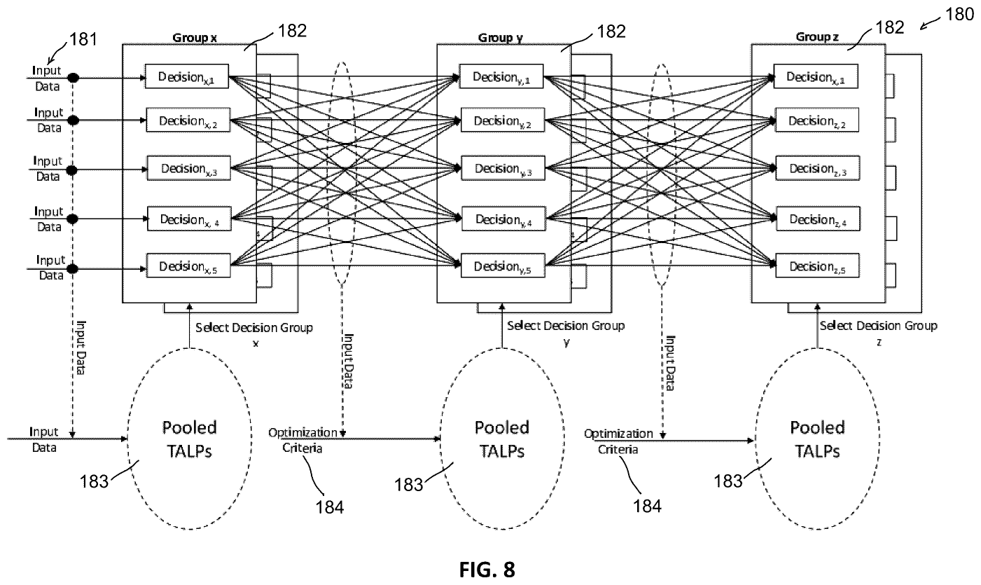

Referring to the diagram 180 of FIG. 8, pooled and parallelized TALPs are shown to be able to select a particular decision group in a set of decision groups. Unlike multiple model AI where multiple models are simultaneously executed and the model with the highest probability for a given query is selected, this invention instead uses the input variable attribute values 181 at each encoder stack, herein called a decision group 182, along with a TALP's extraction of prediction curve fits to select the correct model for the current encoder block. This means that encoder blocks can be mixed and matched through the analysis process, not selected after all encoder blocks have been analyzed for each model. Not only does this speed up the decision analysis, it also seamlessly and dynamically merges multiple AI models. It should be noted that the pooled TALPs 183 can be parallelized and placed into the parallel TALP entries portion of each block of a blockchain. The optimization criteria 184 can be placed into the TALP-enhanced AI processing portion of each block of a blockchain.

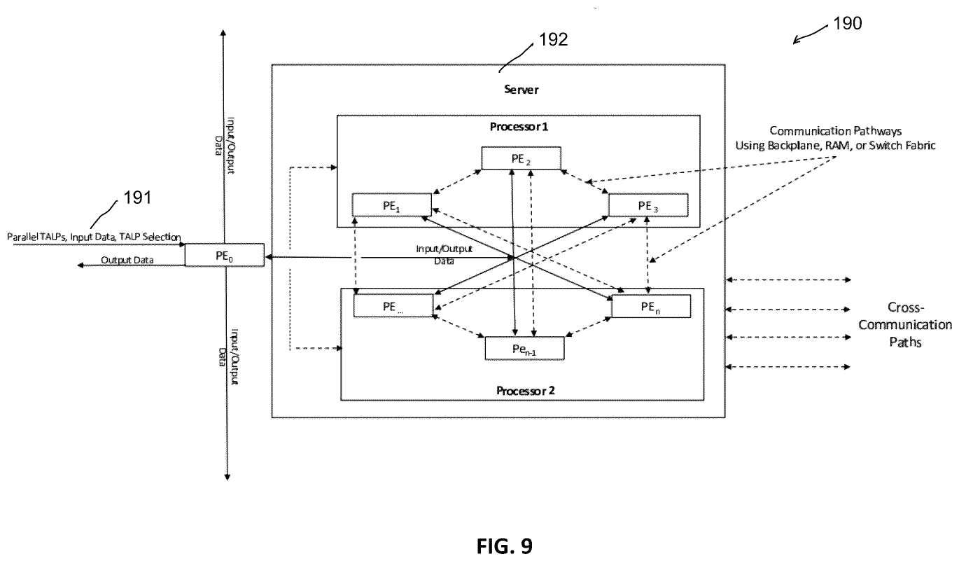

Referring to the diagram 190 of FIG. 9, the parallel, hierarchical execution of a TALP is shown to occur from the allocation of cores, processors, and servers of a blockchain physical network. This figure shows the automatic assignment of a controlling PE (shown as PE₀), single processor multicore parallel processing connections (shown as PE₁ through PE₃), multiple processor parallel processing connections (shown as Processor₁ and Processor₂), and multiple server parallel processing connections (shown associated with Server). Various TALPs 191 are transmitted from the trusted network to the physical devices used by members of the public blockchain network. These devices are called servers 192, regardless of their compute power. Each transmitted TALP comes with a set of analytics that are extracted using the trusted network. The analytics are used to predict the advanced time and advanced space complexity of for each type of device used by members of the public blockchain network. Since the advanced time complexity predicts a TALP's processing time as a function of its input variable attributes (versus the dataset size of standard time complexity) and since the advanced space complexity predicts a TALP's required memory allocation as a function of its input variable attributes (versus the dataset size of the standard space complexity), it is possible to balance the workload of the entire heterogenous blockchain physical network used in the parallel execution of any input dataset for the TALP. The advanced space complexity prediction allows the system to know if a particular device in the blockchain physical network can support the memory requirements of the current input dataset. The level of processing hierarchy required can be determined as a function of the predicted work required.

Consider that some TALPs executed in parallel require cross-communication. Since cross-communication time slows down overall processing time, it can be considered overhead for the parallel executing TALP. This overhead can be predicted by another TALP analytic called overhead complexity. The overhead complexity predicted values are added to the advanced time complexity predicted values to give the complete processing time, called complete advanced time prediction. This more complete time prediction allows TALPs that provide for complex modeling and simulation to be executed on the physical blockchain network, even though the processing elements of the physical blockchain network may be heterogeneous.

The output of TALPs executed on the physical blockchain network are transmitted to the trusted network for vetting, tokenization, and ledger storage as a distributed database.

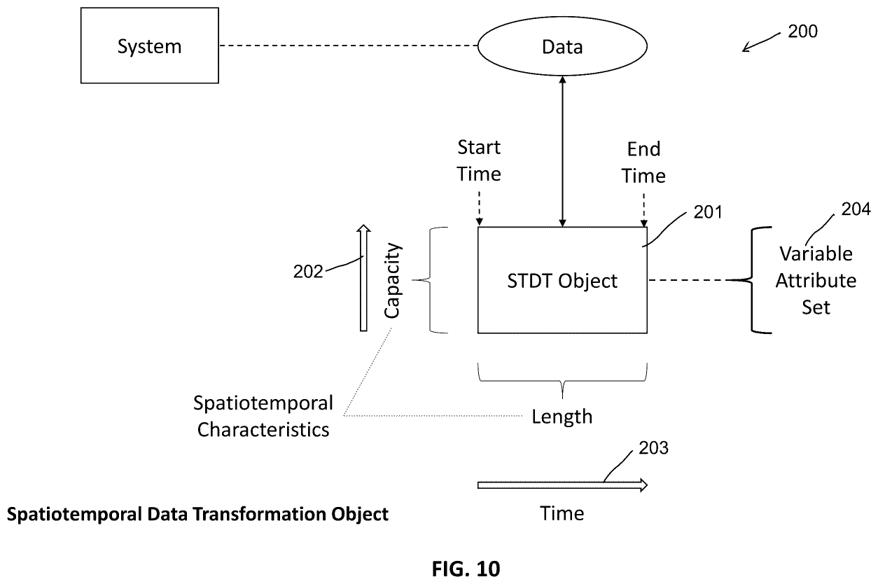

FIG. 10 is a diagram 200 showing Spatiotemporal Data Transformation (STDT) object 201 characteristics for an algorithm. The diagram shows the capacity 202 of the hardware and software used by the algorithm (advanced space complexity), and the processing time 203 of the algorithm (advanced time complexity), combined into a single structure called an STDT object 201. Each STDT object has its own variable attribute data set 204 that is dynamic, automated, and programmable.

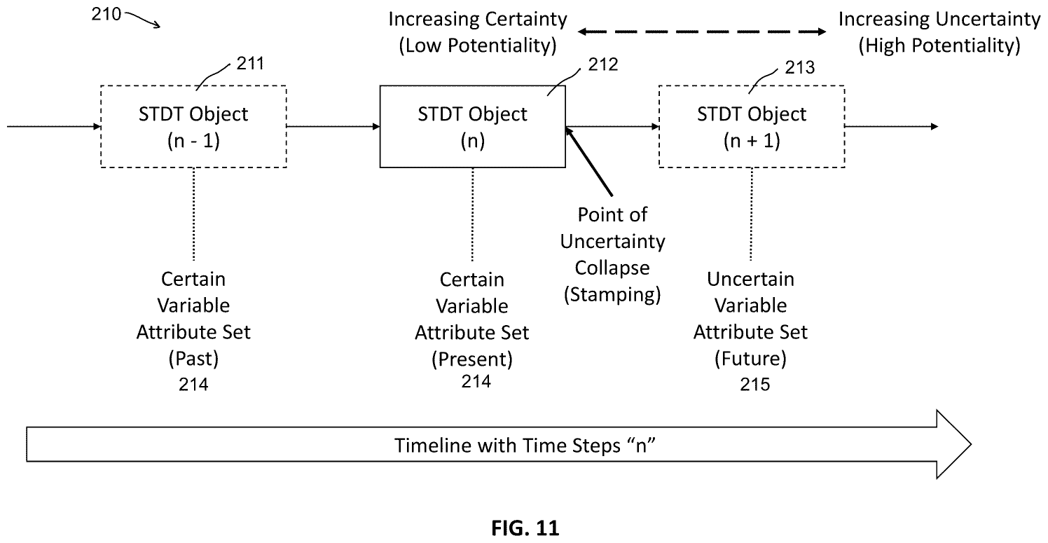

FIG. 11 is a timeline diagram 210 showing how the certainty of an STDT object's variable attribute set changes over time. The variable attribute sets for an STDT object at both past time (n−1) 211 and current time (n) 212 are shown to be certain with zero potential for change 214. The variable attribute set for an STDT object at future time (n+1) 213 is shown to be uncertain with potential for change 215. The closer an STDT object is to current time (n), the less uncertain its variable attribute set is, with less potential for change, up until the point of uncertainty collapse (Stamping).

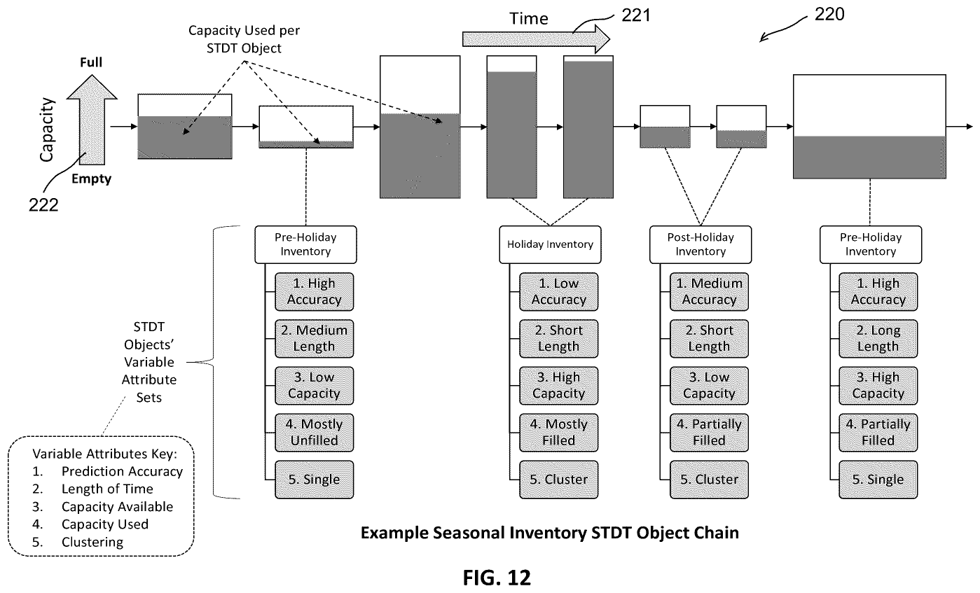

FIG. 12 is a diagram 220 showing an exemplary chain of STDT objects utilized in an inventory application operating throughout a holiday cycle. The figure shows interdependent variability in the STDT objects' variable attribute sets over time, with the second 221 (Length of Time) and third 222 (Capacity Available) attributes in each set determined by prediction data. The first attribute (Prediction Accuracy) shows the level of accuracy of this prediction data. The fourth attribute (Capacity Used) shows the amount of capacity that was utilized by the STDT object. The fifth attribute (Clustering) shows whether an STDT object is a single object or part of a cluster of objects.

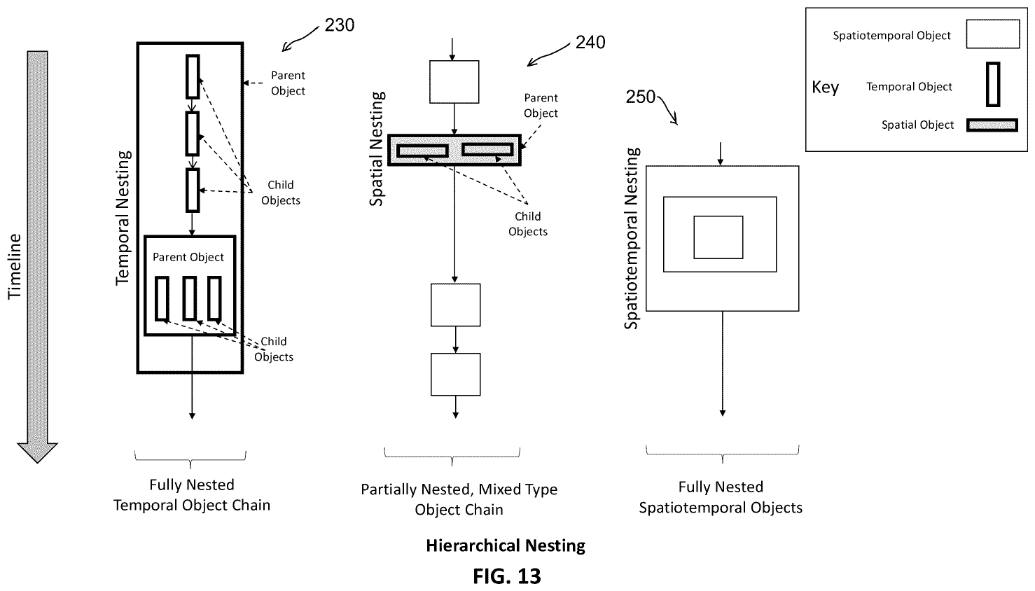

FIG. 13 is a set of three diagrams 230, 240, 250 depicting hierarchical nesting of temporal, spatial, and spatiotemporal data transformation objects. Temporal nesting is when a Temporal Data Transformation (TDT) object occurs within a TDT. Since TDTs have a strong temporal component, such a hierarchical arrangement is a temporal hierarchy. The first sub-diagram 230 shows two TDTs each containing multiple TDTs. At the top-most level of the nesting, there are only nested TDTs; thus, this chain is a fully nested chain. The second sub-diagram 240 shows three Spatial Data Transformation (SDT) objects, one nested and three unnested. This diagram depicts a partially nested chain. The third sub-diagram 250 shows three hierarchically nested STDT objects.

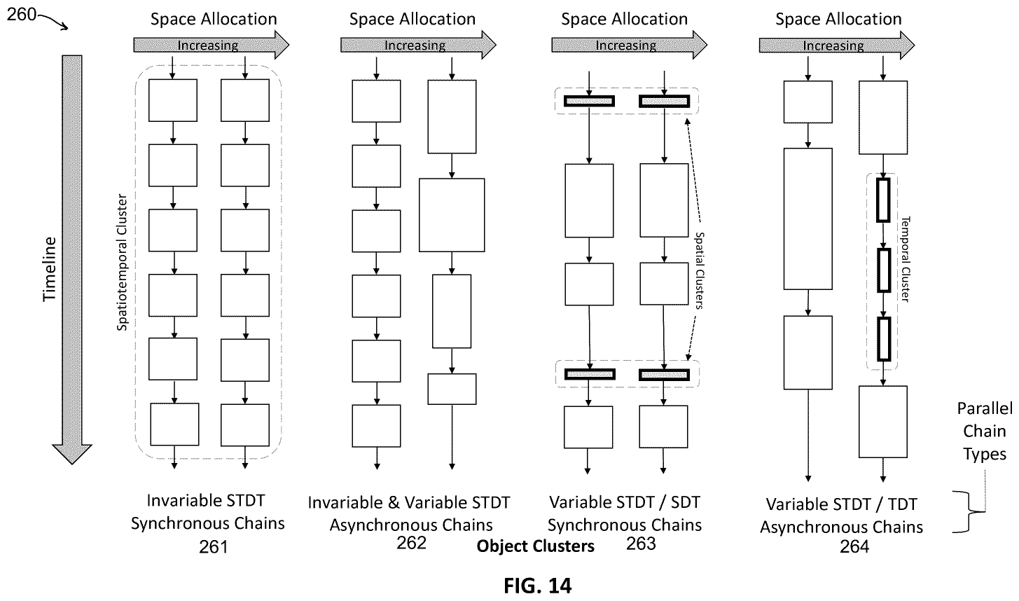

FIG. 14 is a diagram 260 showing four configurations of parallel data transformation object chains. There are three types of data transformation objects shown: temporal (TDT), spatial (SDT), and spatiotemporal (STDT). The first of the parallel data transformation object chains shows two parallel chains 262 of invariable synchronous STDT objects. In this first chain, all STDT objects allocate the same amount of memory and take the same amount of time to process. They also start execution at the same time. This indicates that each STDT object is both invariable and synchronous. This behavior can occur with parallel loop unrolling execution.

The second of the parallel data transformation object chains 262 shows that STDT object processing times and memory allocation can vary between the two STDT object chains, while the processing of each chain occurs in parallel. This behavior can occur during task parallel operations. It should be noted that it is possible for memory allocation or processing time to dominate the STDT object. This is especially true for dynamic changes in either memory allocation or processing time. Dynamic processing time is when the processing time of a TALP analytic is a function of one or more input variable attributes for that analytic. Dynamic memory allocation is when the memory allocation changes as a function of an analytic's input variable attribute values. If the memory allocation is dynamic and the processing time is static (not dynamic) then the object is an SDT object. Analogously, if the processing time is dynamic and the memory allocation is static then the object is a temporal data transformation (TDT) object. If both the memory allocation and processing time are either static or dynamic, the object is an STDT object.

The third of the parallel data transformation object chains 263 shows an instance whereby memory allocation is dynamic while the processing time is static for some set of objects in the parallel chain of objects. As in the first of the parallel data transformation object chains 261, all objects for each parallel chain remain the same for both chains. This represents a synchronized, variable STDT/SDT parallel set of chains of objects or analytics. This type of behavior, as with the first of the parallel data transformation object chains, occurs with loop unrolling.

The fourth of the parallel data transformation object chains 264 show an instance whereby processing time is dynamic while memory allocation is static for some set of objects in the parallel chain of objects. As in the third of the parallel data transformation object chains 263, the objects for each parallel chain can vary between chains. This represents an unsynchronized, variable STDT/TDT parallel set of chains of objects or analytics. This type of behavior, as with the third of the parallel data transformation object chains 263, occurs with task parallel execution.

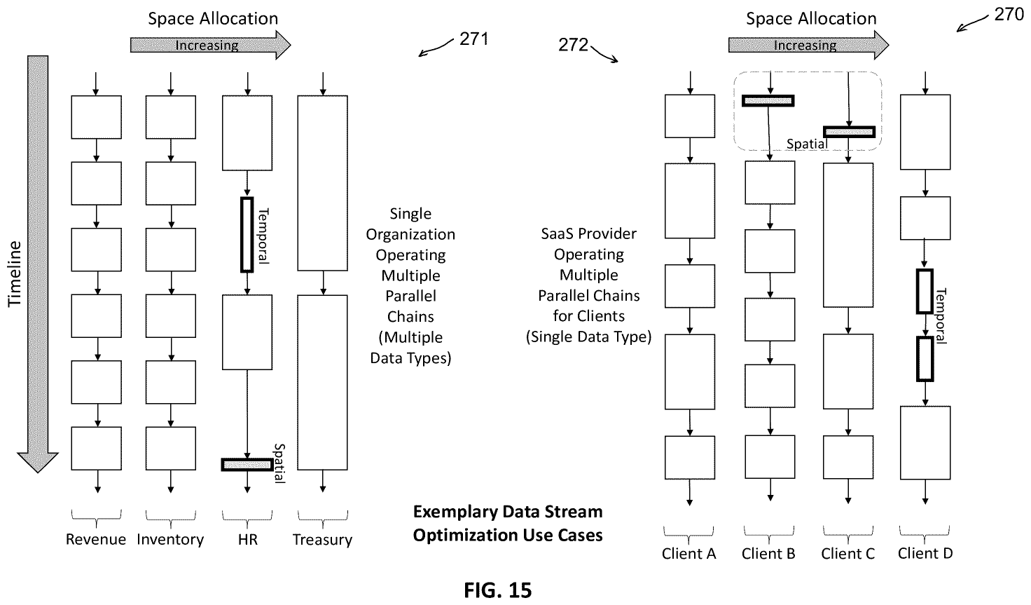

FIG. 15 is a diagram 270 showing two exemplary data stream optimization use cases 271, 272 that each utilize multiple parallel data transformation object chains. The first example 271 represents a single organization operating four parallel data transformation object chains that each process and optimize different types of data streams within the organization: revenue, inventory, human resources, and treasury. The second example 272 represents a software as a service (SaaS) provider operating multiple parallel data transformation object chains that all process and optimize a single type of data stream (inventory) for multiple clients (Clients A, B, C, and D).

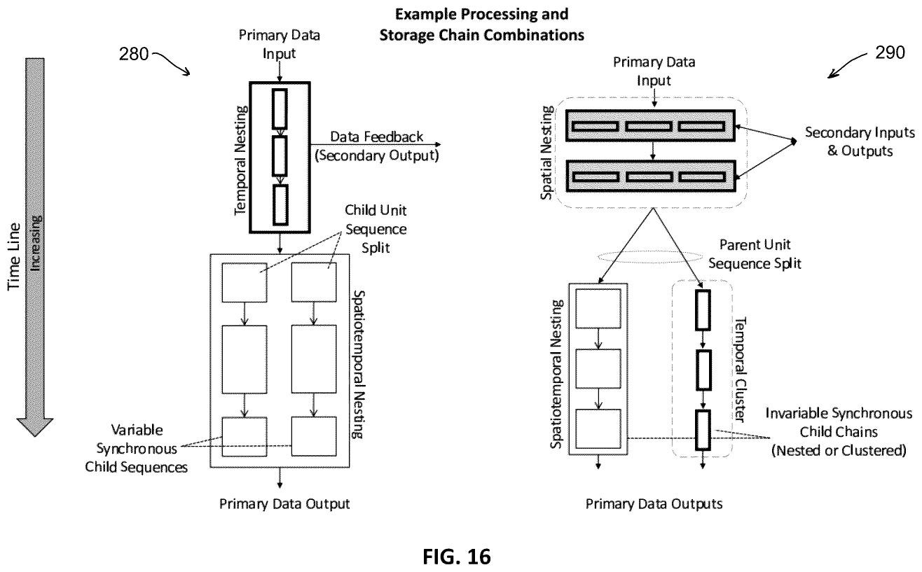

FIG. 16 is an example set of two diagrams 280, 290 used to define the data storage required by the STDTs, TDTs, and SDTs. The first diagram 280 shows two nested SDTs, the first of which is a set of nested TTs that sends its calculated data for reprocessing as a feedback loop and to a hierarchical set spatiotemporal chain. The hierarchical set of spatiotemporal chains show that its input data can be split and shared by two parallel STDT sequences with the outputs synchronized such that a single output stream of data occurs.

The second diagram 290 shows two linked clusters, one a spatial cluster containing a chain of hierarchical SDTs simultaneously linked to both a nested spatial chain and to a temporal cluster containing a chain of TDTs. Primary data is transmitted to the first spatially nested SDT chains, which generates secondary data as well as input data for the second spatially nested STDT and a temporal cluster containing a chain of TDTs. Both the second spatially nested STDT and the temporal cluster are shown generating primary output data.

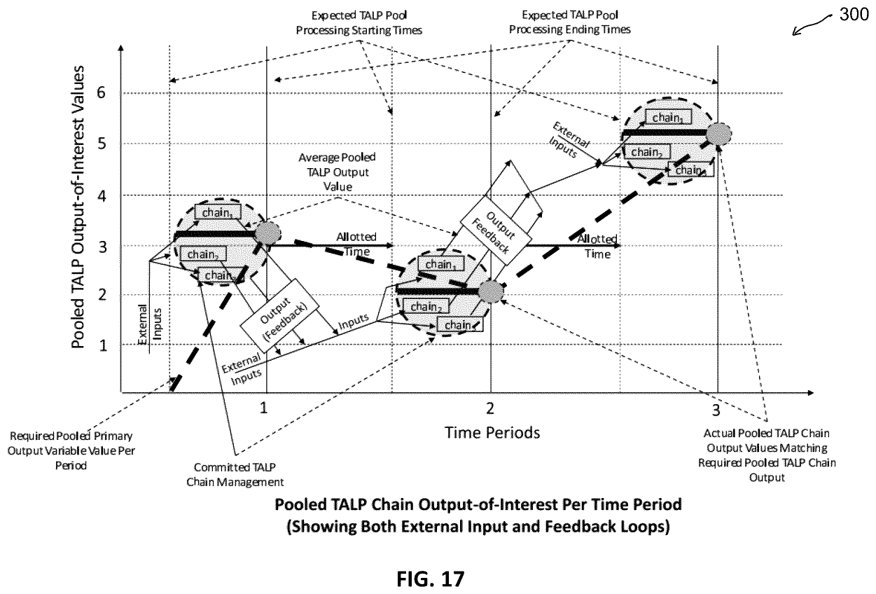

FIG. 17 is a graph 300 showing pooled TALP chains progressing from the start of multiple pooled chains (labelled chain 1 through chain 3). The progression of the chains in time is shown whereby the outputs of the proceeding time units are used as feedback mechanisms to the succeeding time units. These pooled TALP chains can be processed using the parallel processing logical layer of the blockchain public network.

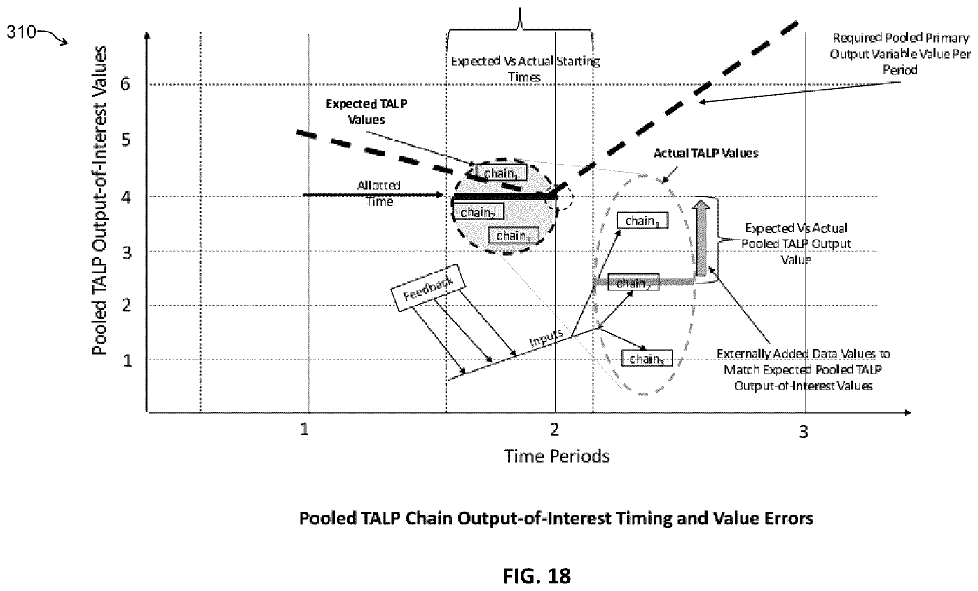

FIG. 18 is a graph 310 showing a set of pooled TALP chains and the effect of both feedback and non-feedback input value amounts on the pooled outputs of the all pooled TALP chains. Also shown are the effects of start times on pooled TALP chain output data production, comparing the expected value amounts to the actual value amounts, given start time delays. As with FIG. 32, the pooled TALP chains can be processed using the parallel processing logical layer of the blockchain public network.

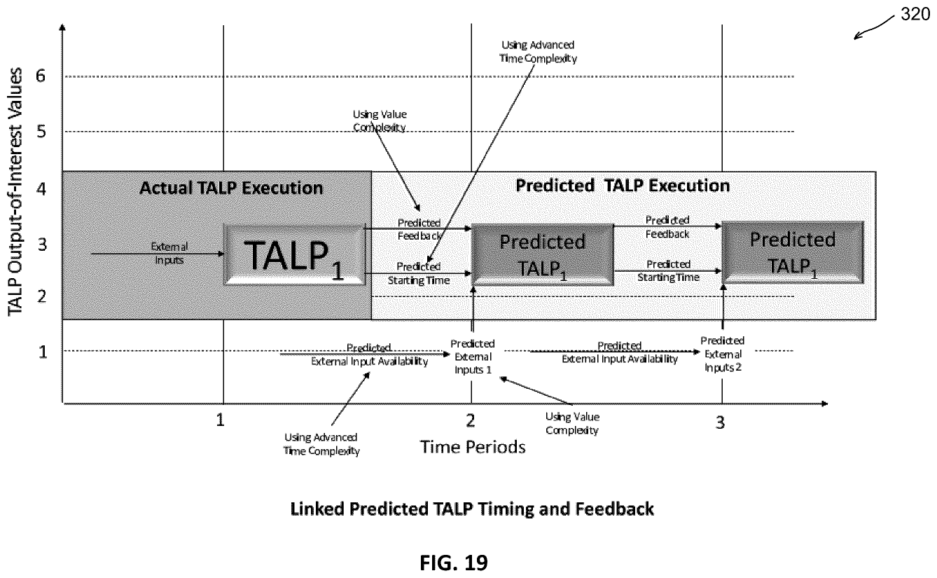

FIG. 19 is a graph 320 showing a detail of the progression in time of a TALP (which can be a TALP chain) and how processing time affects the next TALP or TALP chain processing and thus the amount of output produced. In this case the predicted amount of feedback data is compared to the expected amount feedback data for a particular TALP chain in a TALP.

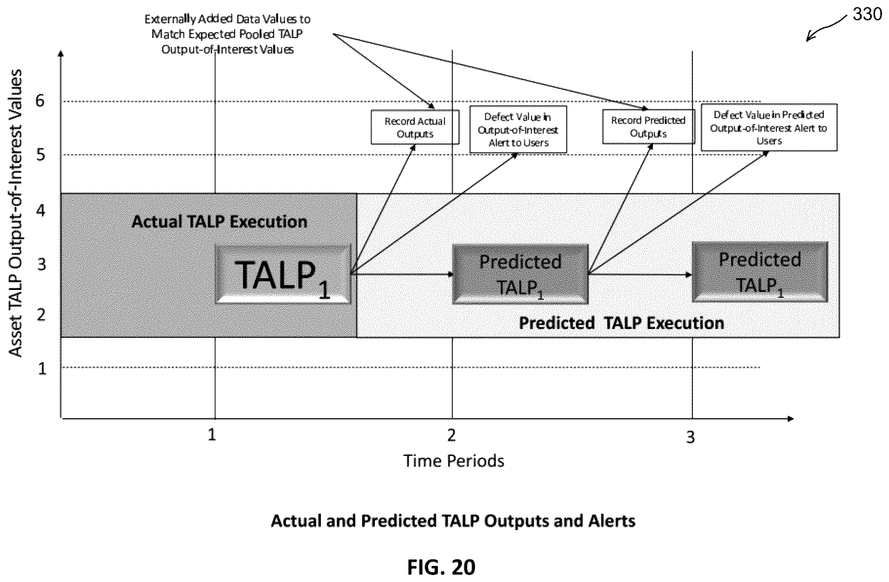

FIG. 20 is a graph 330 showing the recording of output and defect data each time a TALP or TALP chain is executed with feedback from a prior execution of the same TALP.

This system and method is used to store and retrieve data concerning various fund investors, ventures that are capitalized via the fund, and fund operators. The typical fund management software contains information on a venture's risk, return on investment, milestones, milestone progress, capital on hand, capital requirements, and maturity. This information is at least accessible to the system and system operator. Unlike other methods, which only peripherally examine pooled TALPs, this invention explores the various techniques for pooling and using pooled TALPs in areas such as decision networks (a component of generative AI), TALP pool output optimization, and TALP pool output multi-target distribution. In addition, TALP pools are shown to be either spatial, temporal, or spatiotemporal objects. The characteristics and practical use of such objects are explored.

The present invention replaces the “modeling” modules of both U.S. Pat. Nos. 11,687,328 and 11,861,336, with each of these patents fully incorporated herein by reference. After a set of TALPs has been generated from the input/output relationships of various datasets, the analytics for each TALP are found and saved. When applied to an exemplary software system the name is changed to reflect that system. For example, in a private equity fund software E&M system, it might be called a new fund modeling module. However, regardless of the name, there should no mistake on what is occurring in this module: the extraction and execution of the analytics of the TALPs generated from the input/output relationships of datasets or software or algorithms. The analytics for each TALP are extracted and used, along with external and historic data, to select particular TALPs. The TALPs along with their analytics are then shown embedded in a decision network. The output of the decision network is a distribution to multiple groups. The name of the decision network can change as a function of the types of decisions made. When applied to an exemplary software system as discussed above, it might be applied to payments or capital call decisions, in which case the name of the network could become TALP Payment Decision Network or TALP Capital Decision Network. Regardless of the name, what is occurring is the pooling of the analytics of the selected TALPs for use in a decision network. That is, inputs from various external sources (current information from users, acceptance criteria from system operators, etc.) are used to determine a set of conditional probabilities for use in optimizing or distributing data.

This invention shows various TALP pooling techniques. For example, the outputs from the analytics of a set of TALPs can be pooled with no optimization and the unoptimized pooled values used to decide some further action. The members of the pooled unoptimized output values might be changed to increase or decrease the total effect of the pooled values (optimized) with the optimized values first merged and then re-discretized for allocation to others (users, systems, system operators, decision networks, etc.). The optimized pool members can also be used in a feedback loop to change the “unoptimized” pooled TALPs. This is used to either periodically or continuously re-optimize the members of the pool.

In order to optimize a pool of TALPs, the pooled data must be collected, analyzed, and then distributed. The collection phase requires pooled data verification, collation, and matching. That is, the data must pass one or more acceptance criteria and be separable into like types for re-discretization. Analysis consists of both the extraction of analytics, the use of those analytics to calculate values given some set of input values, the use of those analytics to predict future output values and the use of those analytics to determine the allocation and routing of generated output values. The distribution phase requires the target of the distribution be selected (part of the routing from the analysis phase), when the data is to be distributed (from advanced time complexity created from the analysis phase), and notification of the pending distribution to the targets of the distribution list. Optimization is shown to be more than the allocation and deallocation of TALPs to a pool. It is also the discretization model used to prioritize what data goes where. For example, high, medium, and low priority data is distributed to different groups of recipients; that is, the data distribution is optimized for various recipients.

In addition to output distribution, the inputs from various users can be combined and associated with the analytics of various TALPs. These data are shown to be associable with advanced time, space and output prediction analytics, depending on what the input data is.

Each analytic is shown in this invention to be an (STDT) object. These objects are dynamic (they change with the input data presented to them), automated (extraction and use of these objects does not require human intervention), and programmable (chains of these objects can be linked to produce various effects). The components of the STDT include actual start/end times, processing capacity, input/output definitions, and processing bandwidth. Consider that a STDT is an analytic for a TALP. Further consider that each analytic consists of both a static and a variable component. If the STDT has variable spatial aspects but only static temporal aspects then it is considered an SDT. If the STDT has static spatial aspects and variable temporal aspects then it is considered a TDT. The past, present, and future STDTs, SDTs, and TDTs interact through time via their predictive nature. This includes the generation of primary data (output complexity or TALP execution) and secondary data (data from non-output complexity analytics or output complexity analytics data used as a feedback). The primary data can be optimized as discussed above. STDTs, SDTs, or TDTs can be chained together with some or all of the output of a preceding object used as input to a succeeding object. The processing rates, times, and capacity of each object can be used to model the behavior of the chain. Additional input data can be added to any of the chained objects. If only additional data (not data from the output of a succeeding object) is used by an object in the chain and it must occur following some other object in the chain, then it is considered temporally chained.

Objects chains can be nested, that is one or more objects can be part of the TALP. There are nine types of objects chains: fully-nested spatial, partially-nested spatial, fully-nested temporal, partially-nested temporal, fully-nested spatiotemporal, partially-nested spatiotemporal, fully-nested mixed type, partially-nested mixed type, and un-nested.

Object chains can be aggregated into processing clusters. A processing cluster is where the output of multiple objects from one or more processing chains are stored together. Processing clusters normally occur when there are multiple parallel executing object chains. There are eight types of parallel object chains: invariable spatiotemporal, variable spatiotemporal, invariable spatial, variable spatial, invariable temporal, variable temporal, invariable mixed, and variable mixed. As stated above various TALP analytics can be chained together to exhibit various effects. For example, an organization might have multiple, parallel chains that predict revenue, determine inventory, predict personnel requirements, etc.

Different portions of a set of chained objects might be used to determine different aspects of a process. For example, part of a chain might in part be used to determine feedback data while the second part is used to calculate some primary effect. A “chain” can consist of a single object that has a feedback mechanism. Similarly, a pool of objects or chains of objects might also have feedback mechanisms.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order and are not meant to be limited to the specific order or hierarchy presented.

While the present invention has been described in connection with various aspects and examples, it will be understood that the present invention is capable of further modifications. This application is intended to cover any variations, uses or adaptation of the invention following, in general, the principles of the invention, and including such departures from the present disclosure as come within the known and customary practice within the art to which the invention pertains.

It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products.

For purposes of interpreting the claims for the present invention, it is expressly intended that the provisions of 35 U.S.C. § 112 (f) are not to be invoked unless the specific terms “means for” or “step for” are recited in a claim.

All patents, patent application publications, and other publications or disclosures referenced, identified, or listed above are fully incorporated herein by reference.

What is claimed is:

1. A method of a software enhancement and management system, comprising:
inputting one or more data transformation algorithms representing asset data;
decomposing the one or more data transformation algorithms into a plurality of time-affecting linear pathways (TALPs);
executing the plurality of TALPs on a blockchain network to generate one or more TALP-enhanced blockchains, wherein one or more blocks of the one or more TALP-enhanced blockchains include at least TALP-enhanced analytical decision data;
transmitting the one or more blocks of the one or more TALP-enhanced blockchains, including the TALP-enhanced analytical decision data, to one or more trusted network nodes; and
storing the TALP-enhanced blockchains in a time-stamped distributed database of the one or more trusted network nodes.

2. The method of claim 1, wherein each of the one or more blocks of the one or more TALP-enhanced blockchains further comprise one or more ledger entries.

3. The method of claim 1, wherein each of the one or more blocks of the one or more TALP-enhanced blockchains further comprise parallel TALP entries.

4. The method of claim 3, further comprising generating and outputting decision group data from the one or more parallel TALP entries.

5. The method of claim 1, wherein each of the one or more blocks of the one or more TALP-enhanced blockchains further include tokenized participant data.

6. The method of claim 1, wherein the TALP-enhanced analytical decision data includes Artificial Intelligence (AI) processed data.

7. The method of claim 6, further comprising generating and outputting decision data to the one or more trusted network nodes.

8. A software enhancement and management system, comprising:
a memory; and
a processor operatively coupled to the memory, wherein the processor is configured to execute a program code to:
input one or more data transformation algorithms representing asset data;
decompose the one or more data transformation algorithms into a plurality of time-affecting linear pathways (TALPs);
execute the plurality of TALPs on a blockchain network to generate one or more TALP-enhanced blockchains, wherein one or more blocks of the one or more TALP-enhanced blockchains include at least TALP-enhanced analytical decision data;
transmit the one or more blocks of the one or more TALP-enhanced blockchains, including the TALP-enhanced analytical decision data, to one or more trusted network nodes; and
store the TALP-enhanced blockchains in a time-stamped distributed database of the one or more trusted network nodes.
